(19) United States
(12) Patent Application Publication
(10) Pub. No.: US 2022/0172301 A1
(43) Pub. Date: Jun. 2, 2022

(54) SYSTEM AND METHOD FOR CLUSTERING AN ELECTRONIC DOCUMENT THAT INCLUDES TRANSACTION EVIDENCE

(71) Applicant: VATBOX, LTD, Herzliya (IL)

(72) Inventors: David GUEDALIA, Beit Shemesh (IL); Noa KRAFT, Tel Aviv (IL)

(73) Assignee: VATBOX, LTD, Herzliya (IL)

(21) Appl. No.: 17/538,650

(22) Filed: Nov. 30, 2021

Related U.S. Application Data
(60) Provisional application No. 63/119,250, filed on Nov. 30, 2020.

(51) Int. Cl. G06Q 40/00; G06V 30/412; G06V 30/10; G06F 40/186

(52) U.S. Cl. CPC G06Q 40/123; G06F 40/186; G06V 30/10; G06V 30/412

(57) ABSTRACT

A system and method for clustering an electronic document are provided. The method includes performing an analysis of the electronic document that includes transaction evidence and a plurality of items associated with a set of coordinates indicating positioning of each item of the plurality of items within the electronic document; determining for each item of the plurality of items a set of coordinates; analyzing the set of coordinates of each of the plurality of items; determining a first customized radius for the electronic document based on a result of the analysis of the set of coordinates; receiving an input indicating a predetermined minimum number of items required to form a cluster; processing the set of coordinates of each of the plurality of items, the first customized radius and the predetermined minimum number of items to detect a cluster in the document; and generating a electronic template for the cluster.

### CROSS-REFERENCE TO RELATED APPLICATIONS

This application claims the benefit of U.S. Provisional Application No. 63/119,250 filed on Nov. 30, 2020, the contents of which are hereby incorporated by reference.

### TECHNICAL FIELD

The present disclosure relates generally to systems and methods for processing images to provide clustered documented evidences.

### BACKGROUND

As many businesses operate internationally, expenses made by employees are often recorded from various jurisdictions. The tax paid on many of these expenses can be reclaimed, such as the those paid toward a value added tax (VAT) in a foreign jurisdiction. Typically, when a VAT reclaim is submitted, evidence in the form of documentation related to the transaction (such as an invoice, a receipt, level 3 data provided by an authorized financial service company) must be recorded and stored for future tax reclaim inspection. In other cases, the evidence must be submitted to an appropriate refund authority (e.g., a tax agency or the country refunding the VAT) for allowing the VAT refund.

The content of the evidences must be analyzed to determine the relevant information contained therein. This process traditionally had been done manually by an employee reviewing each evidence individually. This manual analysis introduces potential for human error, as well as obvious inefficiencies and expensive use of manpower. Existing solutions for automatically verifying transaction data face challenges in utilizing electronic documents containing at least partially unstructured data.

Automated data extraction and analysis of content objects executed by a computing device enables automatically analyzing evidences and other documents. The automated data extraction provides a number of advantages. For example, such an automated approach can improve an efficiency, accuracy and consistency of processing. However, such automation relies on being able to appropriately identify which data elements are to be extracted for subsequent analysis.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for clustering an electronic document. The disclosed method includes performing an analysis of the electronic document, the electronic document includes transaction evidence and a plurality of items associated with a set of coordinates indicating positioning of each item of the plurality of items within the electronic document; determining for each item of the plurality of items a set of coordinates; analyzing the set of coordinates of each of the plurality of items; determining a first customized radius for the electronic document based on a result of the analysis of the set of coordinates; receiving an input indicating a predetermined minimum number of items required to form a cluster; processing the set of coordinates of each of the plurality of items, the first customized radius and the predetermined minimum number of items to detect at least one cluster in the electronic document; and generating at least one electronic template for the at least one cluster.

Certain embodiments disclosed herein also include a non-transitory computer readable medium having stored thereon instructions for causing a processing circuitry to perform a process for clustering an electronic document, the process including: performing an analysis of the electronic document, the electronic document includes transaction evidence and a plurality of items associated with a set of coordinates indicating positioning of each item of the plurality of items within the electronic document; determining for each item of the plurality of items a set of coordinates; analyzing the set of coordinates of each of the plurality of items; determining a first customized radius for the electronic document based on a result of the analysis of the set of coordinates; receiving an input indicating a predetermined minimum number of items required to form a cluster; processing the set of coordinates of each of the plurality of items, the first customized radius and the predetermined minimum number of items to detect at least one cluster in the electronic document; and generating at least one electronic template for the at least one cluster.

Certain embodiments disclosed herein also include a system for clustering an electronic document. The system including: a processing circuitry; and a memory, the memory containing instructions that, when executed by the processing circuitry, configure the system to: perform an analysis of the electronic document, the electronic document includes transaction evidence and a plurality of items associated with a set of coordinates indicating positioning of each item of the plurality of items within the electronic document; determine for each item of the plurality of items a set of coordinates; analyze the set of coordinates of each of the plurality of items; determine a first customized radius for the electronic document based on a result of the analysis of the set of coordinates; receive an input indicating a predetermined minimum number of items required to form a cluster; process the set of coordinates of each of the plurality of items, the first customized radius and the predetermined minimum number of items to detect at least one cluster in the electronic document; and generate at least one electronic template for the at least one cluster.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram utilized to describe the various embodiments.

FIG. 2 is an example schematic diagram of the evidence analyzer according to an embodiment.

FIG. 3 is a flowchart describing a method for clustering an electronic document that includes at least a transaction evidence, according to an embodiment.

FIG. 4 is a flowchart describing a method for detecting a subcluster that exists within at least one cluster of an electronic document, according to an embodiment.

FIGS. 5A through 5B show exemplary screenshot illustrating an unstructured transaction evidence and a graph utilized to describe the various disclosed embodiments.

FIGS. 6A through 6B show a screenshot illustrating a multiple-invoice image including a three transaction evidences and a graph depicting three corresponding structured electronic templates, according to an embodiment.

FIGS. 7A through 7C show exemplary screenshots illustrating two-steps process for clustering a transaction evidence having at least partially tabular structure, according to an embodiment.

FIG. 8 is a graph that shows the types of items, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In one embodiment, a density-based spatial clustering of applications with noise (DBSCAN) is a data clustering algorithm that may be used. It is a density-based clustering non-parametric algorithm: given a set of points in some space, the algorithm groups together points that are closely packed together (points with many nearby neighbors), marking as outliers points that lie alone in low-density regions (whose nearest neighbors are too far away). The DBSCAN is one of the most common clustering algorithms that may be used with the exemplary embodiments.

Some example embodiments include performing a first analysis of the electronic document, the electronic document includes items, each item is associated with coordinates indicating the items positioning within the electronic document; determining for each item its corresponding coordinates; performing a second analysis of the coordinates; determining a radius for the electronic document; receiving an input regarding a predetermined minimum number of items required to form a cluster; applying an algorithm to the coordinates, the radius and the minimum number of items required to form a cluster. The algorithm is adapted to detect at least one cluster in the electronic document; and, generating at least one electronic template for the at least one detected cluster. The method disclosed herein allows for fast processing of electronic documents in order to determine evidence. The electronic documents may include images that in some cases may be in lower resolutions or quality. The method disclosed herein further allows for fast processing and clustering while reducing utilization of memory.

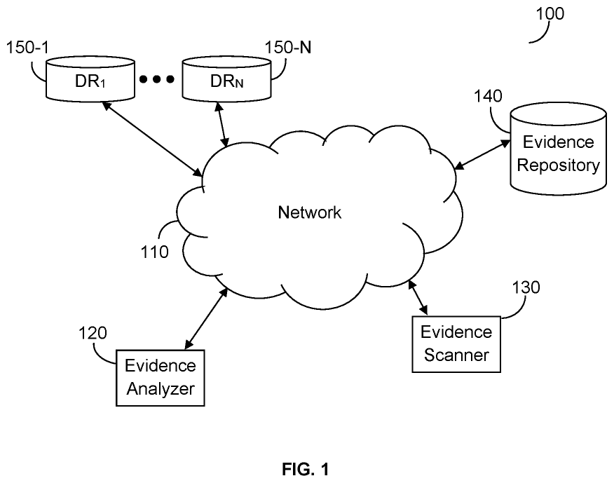

FIG. 1 shows an example network diagram 100 utilized to describe the various embodiments. In the example network diagram 100, an evidence analyzer 120, an evidence scanner 130, an evidence repository 140, and one or more data resources 150-1 through 150-N, where N is an integer equal to or greater than 1 (hereinafter referred to as data source 130 or data sources 130, merely for simplicity), are connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof. In an embodiment, the evidence analyzer 120 is deployed in a cloud computing platform, such as Amazon® AWS or Microsoft® Azure.

The evidence analyzer 120, is configured to analyze using, for example, an optical character recognition (OCR) technique, items (e.g., words, numbers, symbols, and so on.) that appear in an electronic document that includes, for example, transaction evidence, as further discussed herein. Thus, coordinates that are associated with the items can be determined and thereafter used for determining parameters to be fed into a designated algorithm (e.g., DBSCAN) that is adapted to detect at least one cluster within the electronic document, as further discussed herein below.

The evidence scanner 130 is configured to scan evidences, such as tax receipts. The scanner 130 may be installed in or realized as a user device, such as a smartphone with a camera, a stand-alone document scanner, and the like. In an embodiment, the evidence repository 140 is a database containing previously scanned images of, for example, tax receipts. The evidence repository 140 may be local to the evidence analyzer 120, or stored remotely and accessed over, e.g., the Internet. The data resources 150 may be, but are not limited to, data repositories or databases holding a variety of scanned images of evidences.

According to an embodiment, and as further described herein, the system 100 is configured to detect one or more clusters and thereafter generate an electronic template for each cluster that has been detected within the electronic document. As further described herein below, the clustering process includes identification of parameters related to the specific electronic document, such as, a customized radius that is used for determining the relations between different items (e.g., characters, words, numbers, symbols, etc.) in the transaction evidence. As further described herein below, each cluster may include a predetermined number of items. In an embodiment, each cluster may pertain to a different section of the same transaction evidence. According to another embodiment, the electronic document may include several transaction evidences (e.g., two or more tax receipts). According to the same embodiment each cluster may pertain to a different transaction evidence.

It should be understood that the embodiments described herein are not limited to the specific system illustrated in FIG. 1, and other system may be equally used without departing from the scope of the disclosed embodiments.

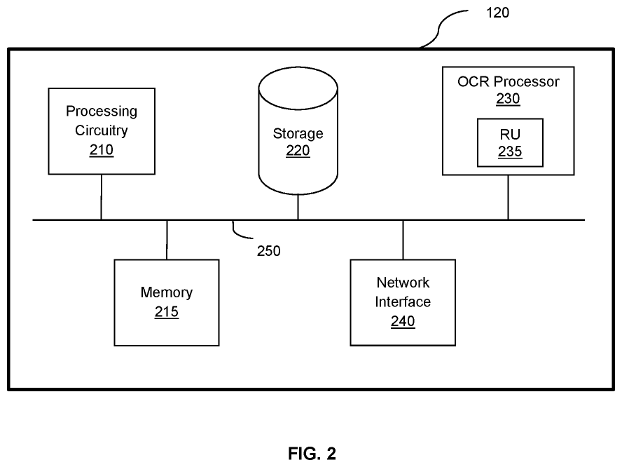

FIG. 2 is an example schematic diagram of the evidence analyzer 120 according to an embodiment. The evidence analyzer 120 may include a processing circuitry 210 coupled to a memory 215, a storage 220, and a network interface 240. In an embodiment, the evidence analyzer 120 may include an optical character recognition (OCR) processor 230. In another embodiment, the components of the evidence analyzer 120 may be connected via a bus 250.

The processing circuitry 210 may be realized as one or more hardware logic components and circuits. For example, and without limitation, illustrative types of hardware logic components that can be used include one or more field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), GPUs, and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

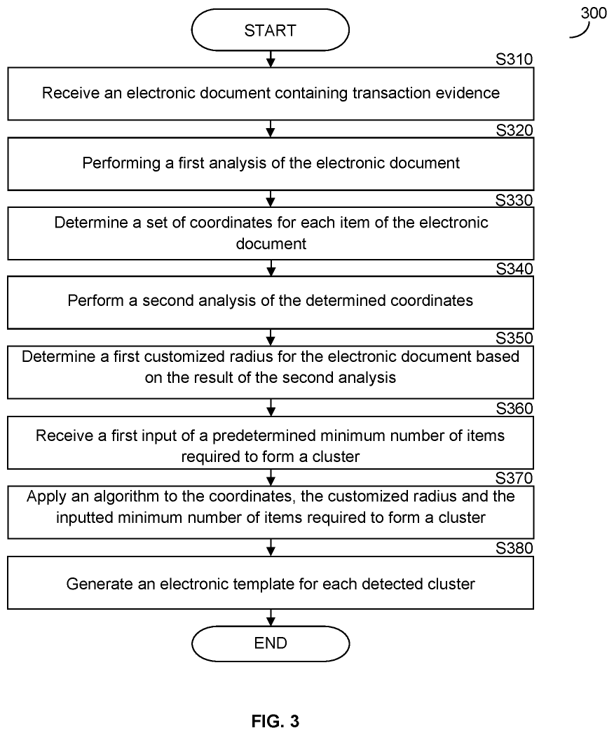

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein. Specifically, the instructions, when executed, cause the processing circuitry 210 to analyze electronic documents (such as receipts received from an evidence scanner 130, an evidence depository 140 or a data resource 150), to automatically identify characteristics related to items appear within the electronic document, determine a customized radius for the electronic document and to generate at least one cluster for each electronic document, as discussed in greater detail herein below with respect to FIG. 3.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature or pattern recognition unit (RU) 235 configured to identify patterns, features, or regions of interest (ROI) in data, e.g., in unstructured data sets. Specifically, in an embodiment, the OCR processor 230 is configured to identify at least a set of coordinates indicating the positioning of each item (e.g., a word, a sentence, a number, etc.) within the electronic document.

The network interface 240 allows the evidence analyzer 120 to communicate with the evidence scanner 130, the evidence depository 140, the data resources 150, or a combination thereof, over a network, e.g., the network 110, all of FIG. 1, for the purpose of, for example, analyzing data, retrieving data, sending reports and notifications, determining clusters which may also refer to as regions of interest (ROIs) in the electronic document, and the like.

It should be understood that the embodiments described herein are not limited to the specific architecture illustrated in FIG. 2, and other architectures may be equally used without departing from the scope of the disclosed embodiments.

FIG. 3 is an example flowchart 300 describing a method for clustering an electronic document that includes at least a transaction evidence, according to an embodiment. In an embodiment, the method may be executed by the evidence analyzer 120 that is further described with respect to FIG. 2.

At S310, a scanned image of a transaction evidence, such as a receipt, is received. The scanned image may be received or collected from a repository, from an external data resource, directly from an evidence scanner, and the like. The scanned image, which may also refer to as electronic document, may include details corresponding to a transaction, including parties involved, date and time of the transaction, amount owed and paid, method of payments, amount taxed, and the like. The electronic document may include unstructured data, semi structured data, and the like.

At S320, a first analysis of the electronic document is performed using optical character recognition (OCR). The electronic document includes a plurality of items, such as words, numerals, symbols, etc. that are be positioned in different areas of the electronic document. Each item of the plurality of items is associated with a set of coordinates indicating the positioning of each item of the plurality of items in the electronic document. For example, the supplier name “Hilton®” may be associated with four coordinates such as top left (x:107, y:66), top right (x:200, y:65), bottom left (x:107, y:86), bottom right (x:200, y:85), indicating the position of the word “Hilton®” within the electronic document. The OCR facilitates extraction of at least the items and the coordinates indicating the position of each item within the electronic document. According to one embodiment, the first analysis may be achieved using machine learning techniques, such as artificial neural networks, deep learning, decision tree learning, Bayesian networks, and the like.

At S330, the set of coordinates is determined for each item of the plurality of items. That is, the electronic document showing the transaction evidence may include several items such as words, numerals etc. that are part of the transaction evidence. It should be noted that each electronic document may include several sections where each section includes several items. A section may relate to the supplier's details (address, name, etc.), transaction details, amount, and the like. Thus, using the OCR, the coordinates of each item of the plurality of items are determined.

At S340, a second analysis of the sets of coordinates is performed. In an embodiment, the analysis may be achieved by applying one or more algorithms to the sets of coordinates in order to detect at least one characteristic of the plurality of items. A characteristic may be for example, the font size, item length, gaps between words, length of the transaction evidence, width of the transaction evidence, and the like. According to another embodiment, the analysis includes calculating the coordinates of all items in order to create a two-dimensional array of all items appear in the electronic document. For example, by analyzing the sets of coordinates, a certain font size shown within the electronic document is detected, a certain gap between words is detected, etc.

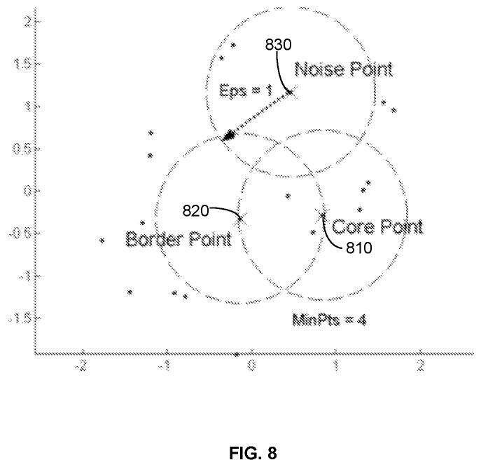

At S350, based on the result of the second analysis a first customized radius is determined for the electronic document. According to one embodiment, a set of predetermined rules (e.g., that may be stored in the memory) may be extracted and used for determining the appropriate customized radius of the specific electronic document based on the characteristics that were previously detected. That is, the selection of the customized radius is affected from the previously detected characteristics of the specific transaction evidence. For example, a rule may indicate that when a font size of 8 is detected within the electronic document, and the gaps between items is 0.5 millimeter, a specific radius shall be selected. The customized radius is used for detecting the type of each item and differentiating between different items (which may also refer to as points) located within the two-dimensional array. There may be at least three types of items: a core item, a border item, and a noise item [as can be seen in example FIG. 8 that shows a graph demonstrating the types of items (or points)]. An item is classified as a core item (e.g., core point 810 in FIG. 8) if it has more than a specified number of items (minimum number of items required to form a cluster, as further discussed herein below) within the customized radius related thereto. In example FIG. 8 the predetermined minimum number of items required to form a cluster is 4. An item may be classified as a border item (e.g., border point 820 in FIG. 8) if it has fewer than the specified minimum number of items required to form a cluster (e.g., 4), but it is positioned within a neighborhood (i.e., maximum radius) of a core point. An item may be classified as a noise item (e.g., noise point 830 in FIG. 8) if it is not a core item nor border item.

At S360, a first input regarding a predetermined minimum number of items required to form a cluster is received. The minimum number of items required to form a cluster may be received as an input from a user device (not shown), designated server, and so on. A cluster is an array of items located in a close proximity to each other. The minimum number of items required to form a cluster may be for example, 4 items, 10 items, 30 items, and so on. As further discussed herein above, a cluster may also refer to as region of interest (ROI).

At S370, at least one algorithm is applied to (a) the set of coordinates of the plurality of items, (b) the first customized radius and (c) the inputted predetermined minimum number of items required to form a cluster. In an example embodiment, the at least one algorithm is density-based spatial clustering of applications with noise (DBSCAN) algorithm. The algorithm may be adapted to detect one or more clusters in the electronic document. As noted above, the clusters are ROIs exist in the electronic document. Each ROI or cluster may be indicative to, for example, receipt date, supplier details, value added tax (VAT) breakdown, purchased items, and so on.

It should be noted that the (a) set of coordinates (b) the customized radius and (c) the predetermined minimum number of items required to form a cluster may be fed into the algorithm, therefore allowing the algorithm to detect or determine the one or more clusters exist in the electronic document. For example, 30 sets of coordinates (where each set is associated with an item) are determined and thereafter analyzed in order to determine the characteristics associated with the items and the electronic document. According to the same example, a customized radius of 20 millimeter is determined based on the analysis of the sets of coordinates, and an input indicating that the minimum number of items required to form a cluster is 3, is received. According to the same example, the abovementioned example data is fed into the algorithm, therefore allowing the algorithm to detect, for example, five different clusters (or ROIs), such as, (1) header (that includes supplier, address, phone number), (2) date, hour, VAT ID, invoice number, (3) transaction details (4) amount, tax (5) footer that includes additional information provided by the supplier.

At S380, at least one electronic template is generated for the at least one detected cluster. As noted above, the abovementioned algorithm may be used for detecting clusters within the electronic document and after the clusters are detected the evidence analyzer 120 may be configured to generate at least one structured electronic template representing the detected cluster(s).

According to an embodiment, the evidence analyzer 120 may be configured to label the at least one cluster with a descriptive label indicating the content and/or context of each cluster. For example, after several clusters of 1,000 invoices (electronic documents) are generated and labeled, the evidence analyzer 120 receives a request to determine how many invoices were issued by the same vendor. In order to extract this information, the evidence analyzer 120 may use only one labeled cluster of each invoice indicating the vendor information. That is, only the relevant clusters may be analyzed and therefore precious processing time may be reduced.

According to another embodiment, the evidence analyzer 120 may be configured to cover at least a portion of the at least one labeled cluster. Covering one or more sections in the transaction evidence based on the labeled clusters may be used for removing irrelevant information, covering private information of employees, and so on.

It should be noted that a single image or a single electronic document may include a plurality of transaction evidences. That is, a scanned image (e.g., an electronic document) may include for example, two (or more) invoices indicating two different transactions. To that end, the disclosed abovementioned method may be used for detecting clusters of transaction evidences and generating an electronic template for each transaction evidence. That is, a plurality of transaction evidences may be identified within a single electronic document based on analysis of the coordinates related to the items (words, numbers, symbols, and so on) of the transaction evidence and the other coordinates appear in the electronic document that may be associated with other transaction evidences. Each of a plurality of transaction evidences located within the electronic document may have similar or different characteristics. Thus, the same customized radius may be determined for the entire electronic document (that includes for example three different tax receipts) based on the characteristics of the entire electronic document.

For example, a relatively large gap between items (e.g., words) may be used as a characteristic for determining a specific customized radius. Then, an input regarding the minimum number of items required to form a cluster may be received. After the coordinates are detected, the customized radius is determined, and the required minimum number of items is received the algorithm that is adapted to detect at least one cluster in the electronic document is applied.

As noted above, the algorithm may be a density-based spatial clustering of applications with noise (DBSCAN) algorithm, that is adapted to detect at least one cluster within the electronic document based on the (a) detected coordinates, (b) customized radius and (c) minimum number of items required to form a cluster. Based on the output of the algorithm, an electronic template is generated where each cluster showing a different transaction evidence. For example, 40 sets of coordinates are extracted from an electronic document, a relatively large gap between items (e.g., words) and different font sizes may be used as characteristics that are utilized for determining a specific customized radius. According to that example, a minimum number of 10 items that are required in order to form a cluster is received. Then, the abovementioned example data is fed into the designated algorithm that is adapted to detect at least one cluster in the electronic document, therefore allowing to determine that there are three different tax receipts within the electronic document.

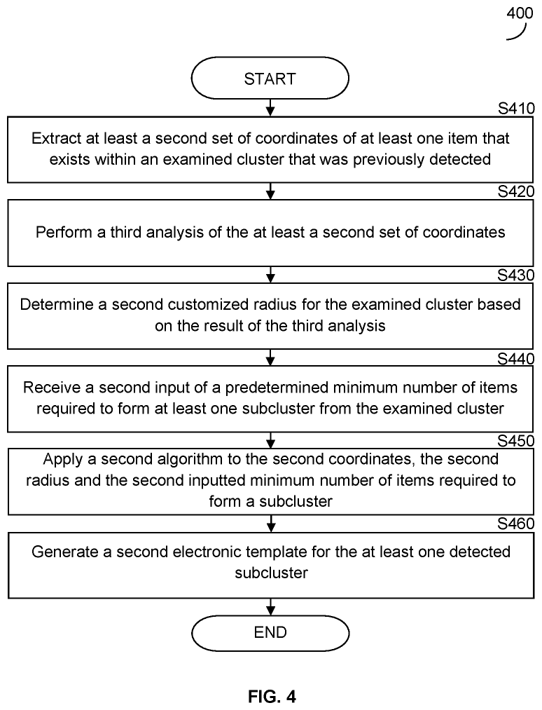

FIG. 4 is an example flowchart 400 describing a method for detecting a subcluster that exists within at least one cluster of an electronic document, according to an embodiment.

At S410, at least a second set of coordinates of at least one item that exists within the at least one detected cluster, is extracted. As noted above, an item may be a character, a numeral, a word, and the like. It should be noted that an optical character recognition (OCR) technique may be utilized for analyzing a specific one or more detected clusters [or regions of interest (ROI) as further discussed herein]. The OCR facilitates extraction of at least the second set of coordinates that is associated with each item that exists within an examined cluster (e.g., a specific cluster that was previously detected). As noted herein with respect to FIG. 3, each item is associated with a set of coordinates indicating the positioning of each item in the cluster. For example, the transaction date may be associated with four coordinates such as top left (x:107, y:66), top right (x:200, y:65), bottom left (x:107, y:86), bottom right (x:200, y:85), indicating the position of the transaction date within a specific cluster related to the transaction details.

At S420, a third analysis of the at least a second set of coordinates is performed. The third analysis may include applying one or more algorithms to the second sets of coordinates in order to detect at least one characteristic of the examined cluster. Such characteristics may refer to the items' font size, items' length, gaps between words (i.e., items), length of the examined cluster, width of the examined cluster, and the like. When analyzed, the at least a second set of coordinates is indicative to at least a second parameter of the examined cluster. That is, based on the result of the third analysis, one or more parameters of the examined cluster may be detected. The second parameter may refer to, for example, a customized radius that is determined based on the detected characteristics of the examined cluster and the items exist within.

At S430, based on the result of the third analysis, at least a second customized radius is determined for the at least one detected cluster. According to one embodiment, a set of predetermined rules (e.g., that is stored in the memory) may be extracted and used for determining the appropriate second customized radius of the at least one examined cluster based on the characteristics of the examined cluster (and the items related thereto) that were previously detected. That is, the selection of the second radius (to be used for generating a subcluster, as further discussed herein below) is affected from the previously detected characteristics of the examined cluster. For example, a rule may indicate that when a font size of 10 is detected within the detected cluster, and the gaps between items is 0.3 millimeter, the selected radius shall be 15 millimeters.

At S440, a second input regarding a minimum number of items required to form a subcluster is received. The second minimum number of items required to form a subcluster may be received as an input from a user device (not shown), a designated server, and so on. A subcluster is an array of items located in a close proximity to each other within a cluster (i.e., a main cluster that was previously detected). As an example, a subcluster may be required to include at least two items, at least three items, and so on.

At S450, a second algorithm is applied to (a) the at least a second set of coordinates, (b) the second customized radius and (c) the second minimum number of items required to form the at least one subcluster. In an example embodiment, the second algorithm is a density-based spatial clustering of applications with noise (DBSCAN) algorithm. The second algorithm may be adapted to detect one or more subclusters within the examined cluster. As noted above, the clusters are regions of interest (ROIs) exist in the electronic document that may be indicative to, for example, receipt date, supplier details, value added tax (VAT) breakdown, purchased items, and so on. In some cases, it may be efficient and therefore desirable to detect a subgroup of items and classify this subgroup as a subcluster. The subcluster may be used for accurately arranging the subgroup of items. For example, a first examined cluster may refer to an entire image of a tax receipt that includes a header, a table describing the purchased goods (e.g., three rows and three columns), and two lines of comments. (That is, the electronic document may include, for example, three tax receipts where each tax receipt is clustered separately such that three main clusters are generated, and each cluster is associated with a single tax receipt.)

According to the same example, by applying the second algorithm, the table may be detected as a subcluster within the main cluster. It should be noted that the (a) the at least a second set of coordinates, (b) the second customized radius, and (c) the second minimum number of items required to form the at least one subcluster may be fed into the second algorithm, therefore allowing the second algorithm to detect the subcluster. For example, ten sets of coordinates (where each set is associated with an item) are extracted from the cluster (i.e., the main cluster) and thereafter analyzed in order to determine the characteristics associated with the cluster and its items, a customized radius of 13 millimeter is determined based on the characteristics of the main cluster, and an input indicating that 2 is the minimum number of items required to form a subcluster, is received. According to the same example, the abovementioned example data is fed into the second algorithm, therefore allowing the second algorithm to detect a subcluster within the examined cluster. It should be noted that the abovementioned at least one algorithm and the at least a second algorithm may be the same algorithm or a different algorithm.

At S460, at least a second electronic template is generated for the at least one detected subcluster. As noted above, the at least a second algorithm may be used for detecting one or more subclusters within the detected cluster, and after a subcluster is detected the evidence analyzer 120 may be configured to generate at least one structured electronic template representing the detected subcluster(s).

According to one embodiment, each of the at least one subcluster may positioned in a corresponding data frame. The positioning may be performed with respect to at least one of one or more parameters of the examined cluster, the other subclusters exist in the detected cluster, etc. A data frame may be a structured dataset of the at least one item (words, numbers, etc.).

According to one embodiment, a gap may exist between the plurality of items (e.g., words, numbers, etc.) shown within the electronic document. There may be two types of gaps, one is a horizontal gap and the other is a vertical gap. According to one embodiment, in order to improve the input that is being used by the abovementioned algorithm (e.g., the first and second algorithm) for clustering the electronic document, the evidence analyzer 120 may be configured to normalize (or reduce) the gaps between the plurality of items in the electronic document.

By reducing the gap between the plurality of items that are horizontally positioned and/or vertically positioned, an enhanced input is generated and can be used by the abovementioned algorithm to create a more accurate clustering. For example, when the electronic document shows transaction evidence having a table with rows and columns, all columns may be shifted towards the vertical axis (the Y-axis) and all rows may be shifted towards the horizontal axis (the X-axis).

It should be noted that normalizing the gaps between the plurality of items may be used not only for processing tabular structures but also for lines alignment, by reducing the gaps between the items (e.g., words, numbers, etc.) appear in a line(s). According to a further embodiment, the technique of normalizing (or reducing) the gaps between a plurality of items that are horizontally positioned and/or vertically positioned within an electronic document that includes at least partially unstructured data, may be used in all cases where the abovementioned is applied. Such technique may be used in order to improve the output the algorithm and therefore provide a more accurate clustering and sub clustering.

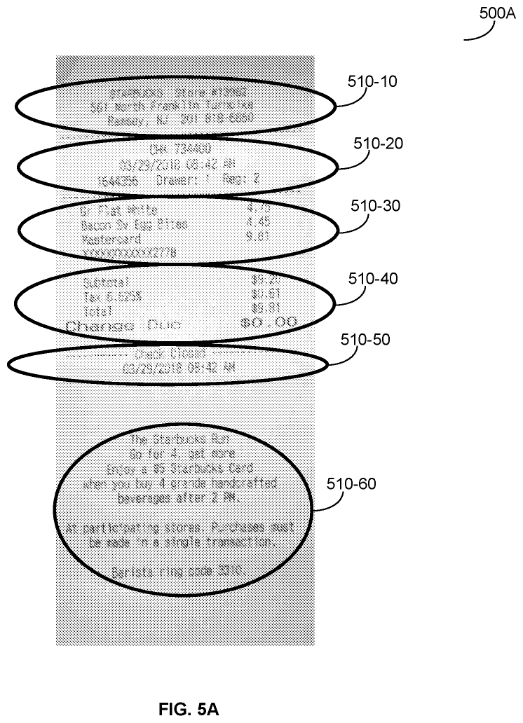

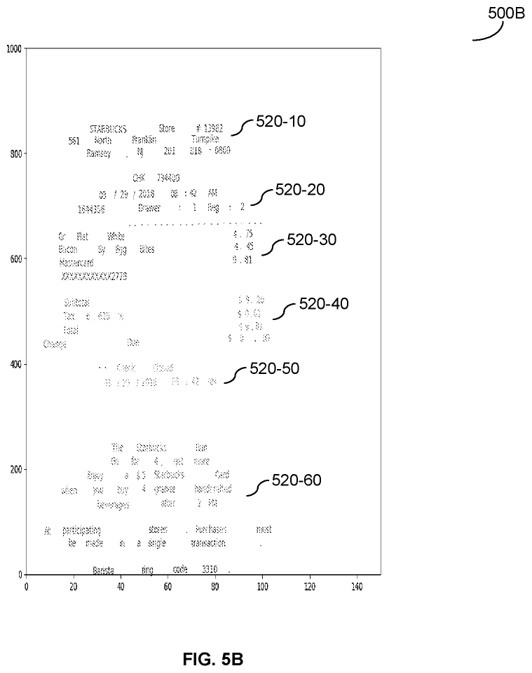

FIG. 5A is an example screenshot 500A illustrating an unstructured transaction evidence 510 according to an embodiment. The example transaction evidence 510 includes six potential clusters 510-10 through 510-60. Cluster 510-10 is invoice header that includes the supplier's details. Cluster 510-20 includes the invoice number, date and time. Cluster 510-30 includes description of the purchased items and the cost of each item. Cluster 510-40 includes the transaction total amount and the VAT breakdown. Cluster 510-50 includes the date and time at which the check was closed. Cluster 510-60 is the invoice footer.

FIG. 5B demonstrates a graph 500B that includes six electronic templates 520-10 through 520-60 generated based on the detected clusters shown in FIG. 5A. The electronic templates are the electronic structured representation of the items shown within the unstructured transaction evidence 510 of FIG. 5A. That is, after a scanned image of an invoice (i.e., electronic document) is received and analyzed using the method described herein above with respect to FIG. 3, an electronic template is generated with respect to each cluster that was detected within the analyzed image. Each electronic template may be labeled based on its context as further discussed herein above.

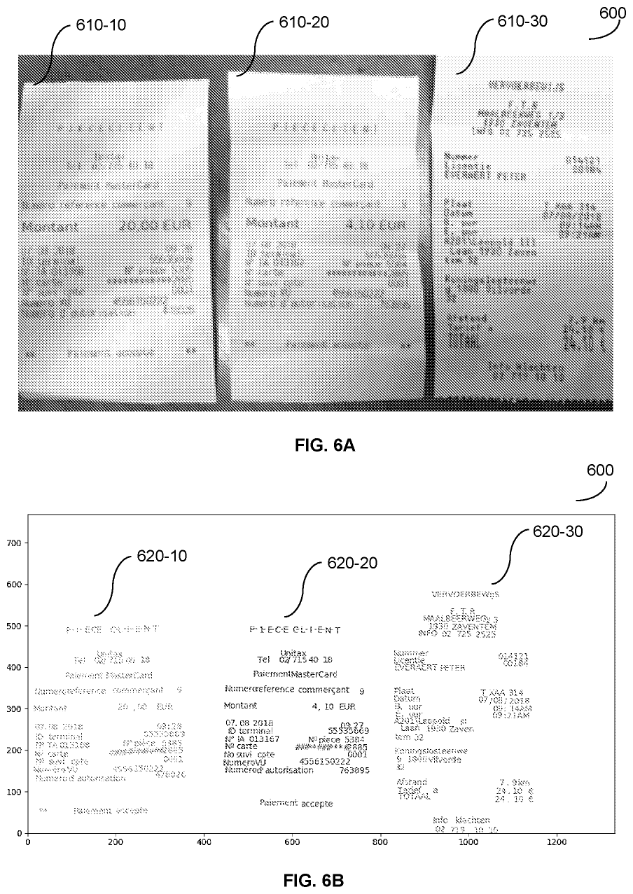

FIG. 6A is an exemplary screenshot 600A illustrating a multiple-invoice image 610 including a three transaction evidences 610-10 through 610-30, according to an embodiment.

FIG. 6B shows an example graph 600B depicting three structured electronic templates 620-10 through 620-30 representing the three unstructured transaction evidences (i.e., invoices) shown in the multiple-invoice image 610 of FIG. 6A. That is, in the example embodiment, three clusters are detected, and each cluster represents a different invoice. Thus, three different electronic templates 620-10 through 620-30 are generated, where each electronic template represents a single invoice.

It should be noted that based on analysis of the coordinates of the items exist within the entire electronic document (of FIG. 6A) and determination of the characteristics of the entire electronic document (font size, gaps between items, etc.), a single parameter (i.e., a customized radius) is determined for the entire electronic document. Then, a minimum number of items required to form a cluster is received and the abovementioned algorithm is applied, as further described herein above. Thus, three clusters are detected and an electronic template is generated for each the detected cluster.

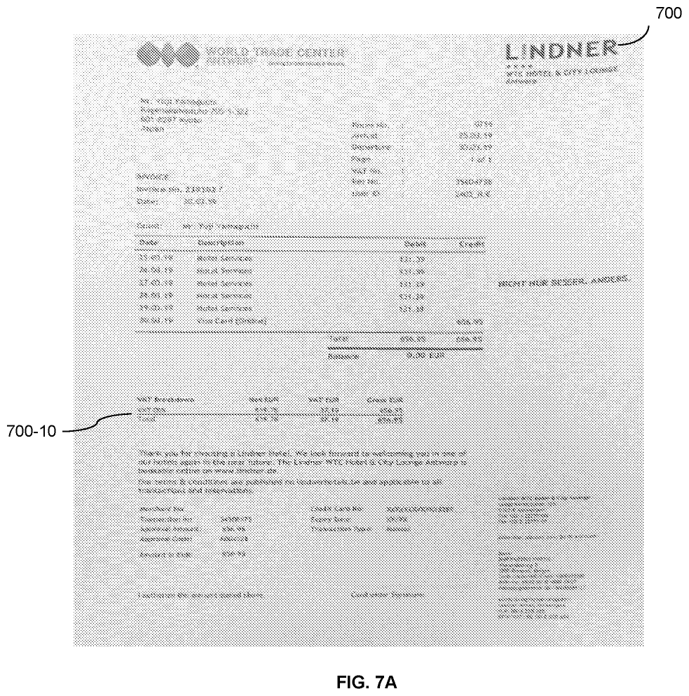

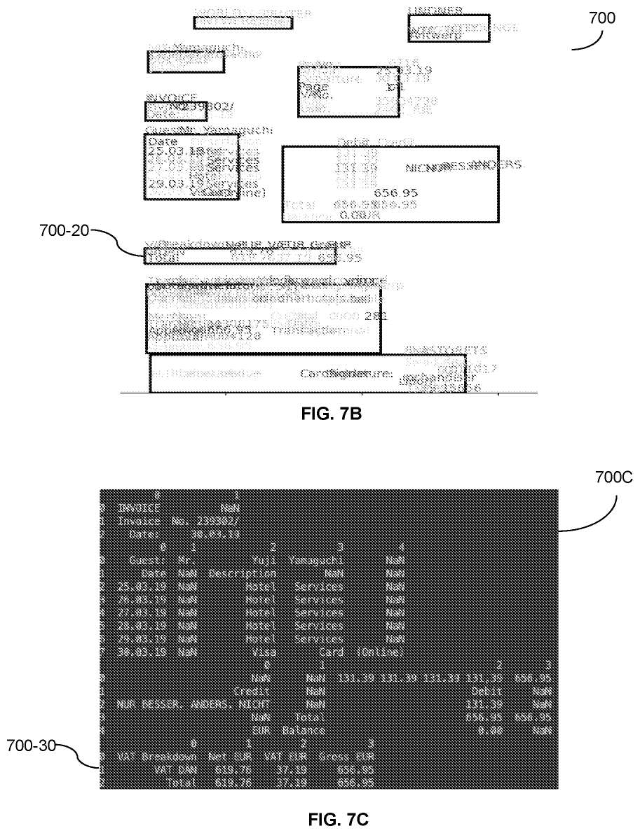

FIG. 7A-7C depict two-steps process for clustering transaction evidence having at least partially tabular structure according to an embodiment. FIG. 7A shows an example image 700A illustrating a scanned invoice that includes, among other sections of the invoice, a tabular structure 710-10 describing the transaction VAT breakdown. At FIG. 7B all sections are clustered and specifically the cluster 700-20 that shows the transaction VAT breakdown, is generated. At FIG. 7C, a second clustering process is performed with respect to the determined cluster 700-20. Thus, a subcluster 700-30 is generated from the cluster 700-20, where the columns and rows of the tabular structure 710-10 are clustered separately therefore allowing for a more accurate determination of each item that exists within the tabular structure 710-10.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for clustering an electronic document, comprising:
performing an analysis of the electronic document, the electronic document includes transaction evidence and a plurality of items associated with a set of coordinates indicating positioning of each item of the plurality of items within the electronic document;
determining for each item of the plurality of items a set of coordinates;
analyzing the set of coordinates of each of the plurality of items;
determining a first customized radius for the electronic document based on a result of the analysis of the set of coordinates;
receiving an input indicating a predetermined minimum number of items required to form a cluster;
processing the set of coordinates of each of the plurality of items, the first customized radius and the predetermined minimum number of items to detect at least one cluster in the electronic document; and
generating at least one electronic template for the at least one cluster.

2. The method of claim 1, wherein the first analysis comprises an optical character recognition (OCR).

3. The method of claim 1, further comprising” labeling the at least one cluster.

4. The method of claim 3, further comprising: covering at least a portion of the at least one labeled cluster.

5. The method of claim 1, wherein the at least one cluster corresponds to the transaction evidence.

6. The method of claim 1, further comprising:
extracting a second set of coordinates of at least one item of the plurality of items stored within the at least one cluster;
performing an analysis of the second set of coordinates;
determining a second customized radius for the at least one cluster based on a result of the analysis of the second set of coordinates;
receiving an input indicating a predetermined minimum number of items required to form at least one subcluster from the at least one cluster;
processing the at least a second set of coordinates, the second customized radius and the second predetermined minimum number of items to detect the at least one subcluster in the at least one cluster; and
generating an electronic template for the at least one subcluster.

7. The method of claim 6, further comprising:
positioning the at least one subcluster in a corresponding data frame.

8. The method of claim 1, further comprising:
reducing a gap between the plurality of items that are horizontally positioned.

9. The method of claim 1, further comprising:
reducing a gap between the plurality of items that are vertically positioned.

10. A non-transitory computer readable medium having stored thereon instructions for causing a processing circuitry to perform a process for clustering an electronic document, the process comprising:
performing an analysis of the electronic document, the electronic document includes transaction evidence and a plurality of items associated with a set of coordinates indicating positioning of each item of the plurality of items within the electronic document;
determining for each item of the plurality of items a set of coordinates;
analyzing the set of coordinates of each of the plurality of items;
determining a first customized radius for the electronic document based on a result of the analysis of the set of coordinates;
receiving an input indicating a predetermined minimum number of items required to form a cluster;
processing the set of coordinates of each of the plurality of items, the first customized radius and the predetermined minimum number of items to detect at least one cluster in the electronic document; and,
generating at least one electronic template for the at least one cluster.

11. A system for clustering an electronic document, comprising:
a processing circuitry; and
a memory, the memory containing instructions that, when executed by the processing circuitry, configure the system to:
perform an analysis of the electronic document, the electronic document includes transaction evidence and a plurality of items associated with a set of coordinates indicating positioning of each item of the plurality of items within the electronic document;
determine for each item of the plurality of items a set of coordinates;
analyze the set of coordinates of each of the plurality of items;
determine a first customized radius for the electronic document based on a result of the analysis of the set of coordinates;
receive an input indicating a predetermined minimum number of items required to form a cluster;
process the set of coordinates of each of the plurality of items, the first customized radius and the predetermined minimum number of items to detect at least one cluster in the electronic document; and
generate at least one electronic template for the at least one cluster.

12. The system of claim 11, further comprising the instructions that, when executed by the processing circuitry, configure the system to label the at least one cluster.

13. The system of claim 12, further comprising the instructions that, when executed by the processing circuitry, configure the system to cover at least a portion of the at least one labeled cluster.

14. The system of claim 11, wherein the at least one cluster corresponds to the transaction evidence.

15. The system of claim 11, further comprising the instructions that, when executed by the processing circuitry, configure the system to:
extract a second set of coordinates of at least one item of the plurality of items stored within the at least one cluster;
perform an analysis of the second set of coordinates;
determine a second customized radius for the at least one cluster based on a result of the analysis of the second set of coordinates;
receive an input indicating a predetermined minimum number of items required to form at least one subcluster from the at least one cluster;
process the at least a second set of coordinates, the second customized radius and the second predetermined minimum number of items to detect the at least one subcluster in the at least one cluster; and
generate an electronic template for the at least one subcluster.

16. The system of claim 15, further comprising the instructions that, when executed by the processing circuitry, configure the system to position the at least one subcluster in a corresponding data frame.

17. The system of claim 11, further comprising the instructions that, when executed by the processing circuitry, configure the system to reduce a gap between the plurality of items that are horizontally positioned.

18. The system of claim 11, further comprising the instructions that, when executed by the processing circuitry, configure the system to reduce a gap between the plurality of items that are vertically positioned.
